(19) United States
(12) Patent Application Publication
(10) Pub. No.: US 2015/0082286 A1
(43) Pub. Date: Mar. 19, 2015

(54) REAL-TIME CODE INSTRUMENTATION

(71) Applicant: Microsoft Corporation, Redmond, WA (US)

(72) Inventors: Arye Gittelman, Mercer Island, WA (US); Aditi Mandal, Bothell, WA (US)

(73) Assignee: Microsoft Corporation, Redmond, WA (US)

(21) Appl. No.: 14/030,008

(22) Filed: Sep. 18, 2013

(51) Int. Cl. G06F 11/36

(52) U.S. Cl. CPC G06F 11/3676
USPC 717/130

(57) ABSTRACT

Systems, methods, and software are disclosed for implementing real-time code instrumentation. In at least one implementation, an instrumentation environment detects a request initiated in an application environment to retrieve at least a portion of an application program for execution in the application environment. The instrumentation environment responsively retrieves application code associated with the application program from a code environment and instruments the application code to generate instrumented code (when operating in an instrumentation mode). The instrumented code may then be included in a reply to the request initiated by the application environment.

### TECHNICAL FIELD

Aspects of the disclosure are related to computing hardware and software technology, and in particular to instrumenting application program code.

### TECHNICAL BACKGROUND

In the context of computer programming, code coverage analysis is one feature of many test suites that determines the extent to which target code has been tested. As a test is applied against the target code, such as an application or module, code coverage analysis can track the coverage of the test with respect to a variety of criteria, such as function, statement, and branch coverage, as well as how much of the code was covered.

In order to perform code coverage analysis, target code must first be instrumented such that any code coverage tools can be applied to the target code. Instrumenting code involves inserting instrumentation code into the target code such that the instrumentation code is executed along with the target code. Binary instrumentation and source instrumentation are two examples of various instrumentation approaches.

A drawback to instrumentation is that the instrumented code resulting from an instrumentation process is inherently slower than the target code in its non-instrumented form because the instrumented code includes more statements for execution. Thus, instrumenting code is less useful for some types of tests than others. For example, when testing for performance, it is less useful to test against instrumented code than when testing for stability.

Code is typically instrumented during the development process. An instrumented version of an application may be created that can be submitted for some tests. The instrumented code may reside on a development server accessible to various clients capable of retrieving and executing the instrumented code in accordance with a specified test. A test suite running in coordination with the client can analyze the code in a variety of ways, including the code coverage accomplished by whichever test is employed.

In one example, an application program may consist of various JavaScript (JS) files developed using the JavaScript (JS) programming language. In order to test the application program, the JS files are instrumented and stored on a server, from which a client (e.g. browser) can retrieve and execute the files as directed by a test suite in accordance with a selected test. As the JS files execute in their instrumented state, the code coverage of the test can be monitored by the test suite.

### OVERVIEW

Provided herein are systems, methods, and software for implementing real-time code instrumentation. Application code that is requested by an application environment for execution can be retrieved and instrumented in real-time. These and other aspects allow for the quick and flexible development and deployment of software applications.

In at least one implementation, an instrumentation environment detects a request initiated in an application environment to retrieve at least a portion of an application program for execution in the application environment. The instrumentation environment responsively retrieves application code associated with the application program from a code environment and instruments the application code to generate instrumented code (when operating in an instrumentation mode). The instrumented code may then be included in a reply to the request initiated by the application environment.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational scenario in an implementation involving code, instrumentation, and application environments.

FIG. 2 illustrates an instrumentation process in an implementation.

FIG. 3 illustrates a computing system suitable for implementing an instrumentation environment or other computing environments.

FIG. 4 illustrates an operational scenario in an implementation.

FIG. 5 illustrates an operational sequence in an implementation.

FIG. 6 illustrates an operational scenario in an implementation.

FIG. 7 illustrates a user interface that may be encountered when experiencing a test suite in an implementation.

FIG. 8 illustrates a user interface that may be encountered when experiencing a test suite in an implementation.

### TECHNICAL DISCLOSURE

Implementations disclosed herein enable application code to be instrumented in real-time, such that application testing and other operations can proceed in a quicker, more flexible manner than otherwise. Rather than instrumenting code and staging the instrumented code such that it can be served to a suitable environment for testing, and optionally for code coverage analysis, non-instrumented code can be staged, served and instrumented in real-time, allowing for improved testing and code coverage analysis.

In at least one implementation, a request may be initiated from an application environment for an application program, or a portion thereof. An instrumentation environment may detect the request and responsively retrieve associated application code from a code environment from which it is served. The application code is then instrumented on-the-fly in the instrumentation environment and communicated to the application environment for execution in an instrumented state.

In some implementations, the application environment may include a user interface through which a user interface control is presented. The user interface control may be selectable to place the instrumentation environment in an instrumentation mode. In other words, the instrumentation environment may be controllable such that at times it functions to instrument code in real-time, while at other times it does not, depending upon the selected state of the user interface control.

A test menu control may also be presented via the user interface in some implementations. The test menu control may be selectable to designate to which test of various tests to submit the requested application program. Thus, a user may interact via the user interface to both select a specific test to apply to an application program, and to select whether or not to test the application program in an instrumented state.

In various scenarios, the application environment may include a browser application from which requests for application programs are initiated. In some examples, the application environment may include a testing application, either running in the browser application or externally to it. In addition, the instrumentation environment may include a proxy server loaded in the browser application. In such scenarios, the browser application may initiate requests that are detected by the proxy server, which in turn retrieves and instruments any requested code. The testing application may interface with the browser application to drive the execution of the instrumented code in accordance with a selected test.

However, it may be appreciated that other scenarios are possible that do not involve a browser application. Rather, the application environment could include other types of applications, other than a browser, capable of requesting application code and executing application code. For example, special purposes applications operating systems may include functionality suitable for requesting and executing application code, in an instrumented or non-instrumented state.

It may also be appreciated that the proxy server may be implemented in various ways. As mentioned above, the proxy server may be loaded in a browser application. However, the proxy server may also be implemented in a code environment from which application code is served. In some scenarios, the proxy server may be implemented in an intermediate fashion such that it is neither integrated with an application environment nor integrated with a code environment.

The code environment may include, in some scenarios, a production server on which application code is staged and from which the application code may be served for execution by a variety of application environments. In other scenarios, the code environment may include a development server on which the application code is developed and from which it can be server for execution.

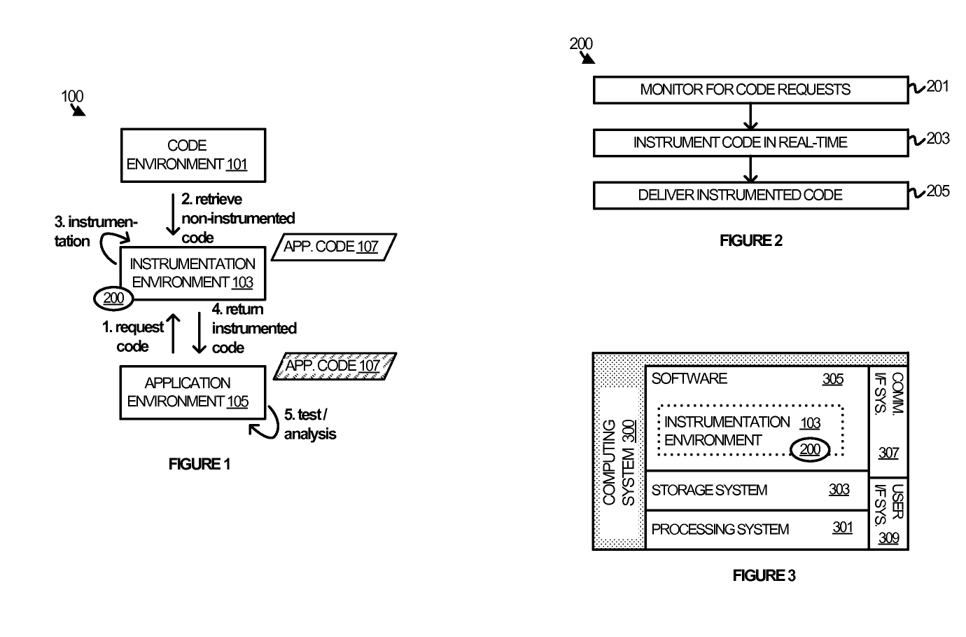

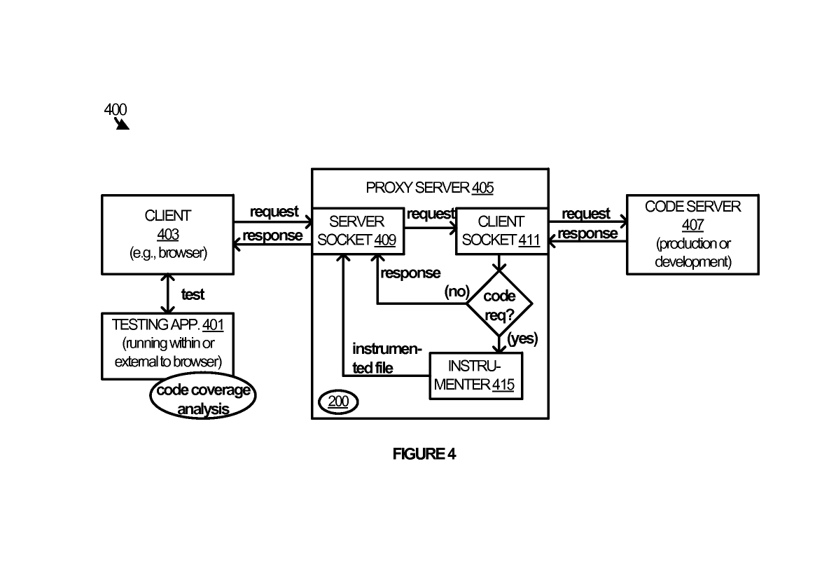

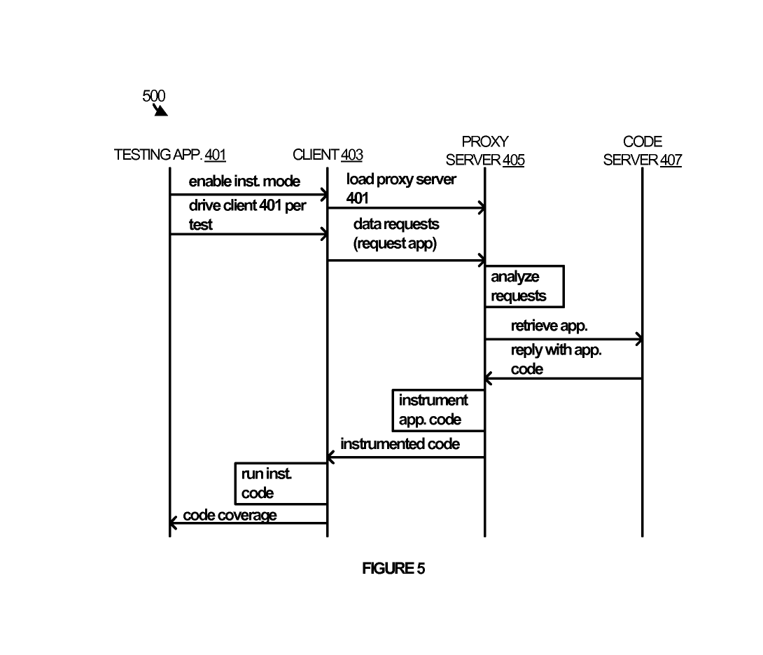

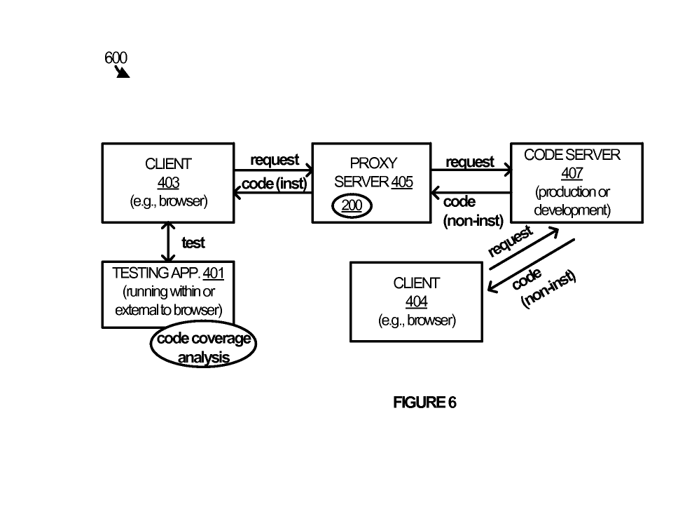

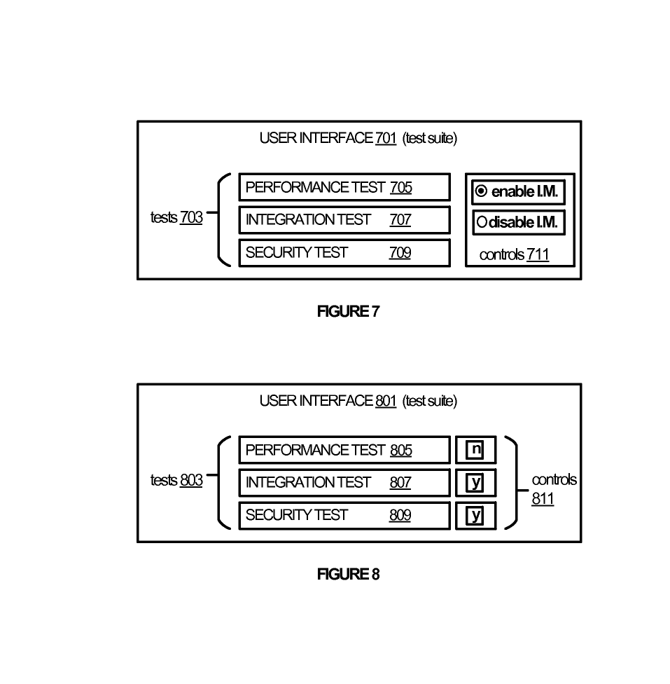

Referring now to the drawings, FIG. 1 illustrates an operational scenario in which code is retrieved and instrumented in real-time for testing and analysis. FIG. 2 illustrates an instrumentation process that may be carried out in an instrumentation environment in the context of the operational scenario illustrated in FIG. 1. FIG. 3 illustrates a computing systems suitable for implementing any or all of the various environments, scenarios, sequences, and processes illustrated in FIGS. 1-2. FIG. 4 illustrates another operational scenario in which code is instrumented in real-time, while FIG. 5 illustrates a related operational sequence, both of which may be implemented by any suitable computing system such as is illustrated in FIG. 3. FIG. 6 illustrates another operational scenario and FIG. 6 and FIG. 7 illustrate various user interfaces representative of those that may be encountered when experiencing a test suite via which various tests and analysis may be controlled.

Turning now to FIG. 1, operational scenario 100 is illustrated in an implementation. Operational scenario 100 involves various interactions between code environment 101 and instrumentation environment 103, and between instrumentation environment 103 and application environment 105.

Code environment 101 may be any computing environment from which program code may be served to requesting clients. Examples of code environment 101 include production servers, software development servers, or on any other type of server. Code environment 101 may be implemented in hardware or software, or in a combination of hardware and software.

Instrumentation environment 103 may be any computing environment in which an instrumentation process 200, referred to in more detail with respect to FIG. 2, may be carried out such that non-instrumented code may be processed to generate instrumented code in real-time. Examples of instrumentation environment 103 include proxy servers, application servers, or any other type of server. Instrumentation environment 103 may be implemented in hardware or in software, or in a combination of hardware and software. In addition, instrumentation environment 103 may be implemented in a stand-alone fashion or may be integrated with other environments, such as application environment 105.

Application environment 105 may be any computing environment from which requests for non-instrumented code may originate and through which instrumented (or non-instrumented) code may be executed. Application environment 105 may be implemented in hardware or in software, or in any combination thereof. In addition, application environment 105 may be implemented in a stand-alone fashion or may be integrated with other environments, such as instrumentation environment 103.

Application code 107 is representative of any program code that may be served by code environment 101, instrumented by instrumentation environment 103, and executed by application environment 105. Application code 107 may be any type of program code capable of being served, instrumented, and executed, including source code, binary code, interpreted code, assembly code, machine code, or any variation or combination thereof. Application code 107 may be code representative of a complete application, or even multiple applications, but may also be representative of just a portion of a program or application.

In operational scenario 100, application environment 105 initiates a request for application code 107 associated with an application program. The application code 107 may be, for example, source code, binary code, or some other type of code. The request may identify the application code 107 specifically, but may identify the application code 107 in some other manner, such as by a reference to the application program, a file, an address or location, or the like.

Instrumentation environment 103, implementing instrumentation process 200, detects the request and responsively retrieves the application code 107 from code environment 101. Instrumentation environment 103 processes the application code 107 to transform it from a non-instrumented format to an instrumented format, as represented by the different fill pattern in each instance of application code 107 in FIG. 1. Instrumentation environment 103 then replies to the request initiated by application environment 105 with the application code 107 in its instrumented format. Application environment 105 can then commence with any suitable testing and analysis, including code coverage analysis.

Referring to FIG. 2, instrumentation process 200 may be employed by instrumentation environment 103 to facilitate real-time instrumentation within the context of a variety of operational scenarios, such as operational scenario 100. In operation, instrumentation environment 103 monitors for code requests initiated by application environment 105 (step 201). This may entail, for example, examining a variety of different kinds of requests to identity those that are requesting application code.

Upon detecting a request for application code, instrumentation environment 103 retrieves the application code and processes it to generate instrumented code (step 203). Instrumenting the application code may be accomplished in a variety of well-known ways, such as by injecting instrumentation code into the application code such that the instrumentation code can be executed along with at least portions of the application code.

Having instrumented the application code, the instrumented code can be delivered to application environment 105 (step 205). As the instrumented code is executed in application environment 105, various types of analysis can be performed, such as code coverage analysis, as the instrumentation code injected into the application code during the instrumentation process is encountered.

It may be appreciated that by instrumenting code in real-time reduces the effort needed to analyze the code coverage of a particular test. As a result, code coverage of a test may be performed more frequently than otherwise and the quality of associated application programs may be improved. This may be especially beneficial under circumstances in which applications have short release cycles and are routinely updated.

In addition, such implementations allow the very same application code deployed on a production server to be subjected to testing and code coverage analysis. For example, a production server may serve the same, non-instrumented application code to two different application environments, while each application environment may experience the code differently. One application environment may execute the non-instrumented code, while another may execute the code in an instrumented state.

Referring now to FIG. 3, computing system 300 is representative of any suitable computing system that may be employed to implement all or portions of at least instrumentation environment 103 and instrumentation process 200 or variations thereof, and optionally any of the other environments, user interfaces, and operational scenarios and sequences described herein. For example, computing system 300 is also representative of any computing system suitable for implementing all or portions of code environment 101 and application environment 105. Instrumentation environment 103 and instrumentation process 200 may be implemented on a single apparatus, system, or device or may be implemented in a distributed manner. Application environment 105 and code environment 101 also may each be implemented on a single apparatus, system, or device, or may each be implemented in a distributed manner.

Examples of computing system 300 include, but are not limited to, desktop computers, laptop computers, tablet computers, notebook computers, mobile computing devices, cell phones, media devices, and gaming devices, as well as any other type of physical or virtual computing machine and any combination or variation thereof. Other examples of computing system 300 may also include server computers, cloud computing platforms, and data centers, as well as any other type of physical or virtual server machine, and any variation or combination thereof.

FIG. 4 illustrates operational scenario 400 in an implementation. In operational scenario 400, a user may interact with testing application 401 to run a test against a target application. The target application may be executed by client 403 upon being downloaded through proxy server 405 from code server 407. Proxy server 405 employs instrumentation process 200, or a variation thereof, to instrument the target application in real-time when it is requested by client 403 for execution.

Testing application 401 may be any application or suite of applications capable of testing the performance or other characteristic of target applications. Testing application 401 may render a user interface, two examples of which are illustrated in FIG. 7 and FIG. 8, may provide a user with various options for configuring a test. For example, a particular test may be selected. In addition, whether or not the target application is to be instrumented prior to the test can be specified.

In operational scenario 400, testing application 401 interfaces with client 403 to drive the testing of the target application. Client 403 may be an application capable of being driven for testing purposes, such as a browser application. However, it may be appreciated that other types of clients are possible. In some scenarios, testing application 401 is integrated with client 403. For example, testing application 401 may be a testing framework loaded and executed within the context of a browser application. In other scenarios, testing application 401 may be separate from client 403. In most scenarios, testing application 401 and client 403 reside on and are executed by the same physical computer (of which computing system 300 is representative) or virtual machine. However, in other scenarios, testing application 401 may be loaded in and running on a physical computer entirely different than the physical computer on which client 403 may run.

At the direction of testing application 401, or possibly independent of testing application 401, client 403 initiates a request process to obtain the target application for testing. In this example, the target application resides on code server 407, which may be a production serer, a development server, or any other type of server capable of serving the target application for execution by client 403. However, rather than communicating directly with code server 407, any requests made by client 403 are instead communicated through proxy server 405. In some scenarios, the requests may be initially direct to code server 407 and then intercepted and re-routed to proxy server 405. In other scenarios, client 403 may intentionally direct requests to proxy server 405. Still other scenarios are possible and may be considered within the scope of the present disclosure.

Proxy server 405 includes various elements to enable it to process requests initiated by client 403 such that those requesting target applications can be identified and resulting code instrumented. In some scenarios, proxy server 405 is integrated with client 403. For example, proxy server 405 may be a proxy loaded and executed within the context of a browser application. In other scenarios, proxy server 405 may be separate from client 403. In most instances, proxy server 405 and client 403 reside on and are executed by the same physical computer (of which computing system 300 is representative) or virtual machine. However, in other instances, proxy server 405 may be loaded in and running on a physical computer entirely different than the physical computer on which client 403 may run.

Proxy server 405 includes server socket 409, client socket 411, and instrumenter 415. Server socket 409 is any socket element capable of listening to a particular port on a client machine in which client 403 and proxy server 405 are implemented to identify requests initiated by client 403. For example, server socket 409 may listen to a certain fixed port to which client 403 may direct hypertext transfer protocol (HTTP) traffic. Upon detecting a request, server socket 409 communicates the request to client socket 411.

Client socket 411 may be any socket element capable of communicating with server socket 409 and with code server 407. Client socket 411 receives requests forwarded to it by server socket 409 and examines them to determine if they are requests for code that could potentially be instrumented, or requests for some other type of content. For example, client socket 411 may parse HTTP headers to detect HTTP GET requests for JavaScript files associated with a target application available via code sever 407.

In the event a request for code is detected, client socket 411 communicates with code server 407 to request the code, such as a JavaScript, in response to which code server 407 provides the code in a non-instrumented format. The non-instrumented code is handled by instrumenter 415, which may be any element capable of automatically instrumenting code. In the event that a request is for something other than code, the request is served by code server 407 and any content provided in response is forwarded by proxy server 405 to client 403. Likewise, upon instrumenting code retrieved from code server 407, the instrumented code is sent to client 403.

Client 403 then loads and executes the instrumented code, the execution of which may be driven by testing application 401 in accordance with a specified test. Because the code is in an instrumented format, code coverage analysis can be performed with respect to the specified test.

In some scenarios involving JavaScript files, when a test is run, the injected instrumentation code in the JavaScript files can detect code blocks that are hit and store that information in in-memory data structures. After a test is complete, a test framework (implemented via testing application 401) stops proxy server 405 and resets the proxy settings of the computing system on which proxy server 405 runs. Code coverage information collected in the in-memory data structures may be parsed to create a coverage report for the completed tests. In some scenarios, the code coverage information may also be stored a browser's local storage to persist coverage data across multiple test runs which can then be coalesced or compared.

FIG. 5 illustrates an operational sequence 500 in an implementation involving various elements referred to with respect to operational scenario 400 to further elaborate on some aspects of the disclosure. In operational sequence 500, a user interacting with testing application 401 by way of a user interface may enable proxy server 405 to run in an instrumentation mode. In the instrumentation mode, proxy server 405 is set to instrument code that is retrieved from code sever 407. In a non-instrumented mode, proxy server 405 would be set to not instrument the same code.

Client 403 loads proxy server 405 in accordance with the mode selected in the previous step. In addition, client 403 is then driven by testing application 401 to communicate data requests intended for code server 407 that are handled by proxy server 405. As discussed with respect to operational scenario 400, proxy server 405 examines each request to determine if code is implicated that may need to be instrumented. In the event a request is for target code, and assuming proxy server 405 is running in an instrumentation mode, the code is retrieved by proxy server 405, instrumented, and sent to client 403. Client 403 may then execute the instrumented code in accordance with a test procedure specified by testing application 401 or some other element that may direct client 403.

FIG. 6 illustrates operational scenario 600 in which two different situations are carried out. In one case, client 403 requests code from code server 407 that is instrumented in real-time by proxy server 405 in accordance with instrumentation process 200. It may be appreciated from operational scenario 600 that the code, which may be associated with a target application hosted by code server 407, is initially in a non-instrumented mode and is altered by proxy server 405 and sent to client 403. Thus, testing application 401 may perform code coverage analysis or some other type of analysis with respect to the code and a specified test.

In addition, the same code may be requested at the same time from some other client 404. Client 404 does not communicate through proxy server 405 and thus the code is not instrumented. Even if client 404 were to communicate through proxy server 405 or some other proxy server, that server could run in a non-instrumented mode such that any code retrieved from code server 407 for client 404 would remaining in a non-instrumented state.

In fact, it may be appreciated that a similar situation may occur with respect to client 403 in that, in one instance, client 403 may request code via proxy server 405 in an instrumented mode (resulting in instrumented code), while in another instance request the same code via proxy server 405 in a non-instrumented mode (resulting in non-instrumented code). In this manner, the same code may be tested and analyzed in various ways and at various times without having to re-engineer the code on code server 407.

FIG. 7 illustrates one exemplary user interface 701 that may be rendered and experienced by a user when interacting with testing application 401. User interface 701 includes various graphical representations of tests 703 selectable by a user to specify which test or tests to run against a target application. For example, a user may select from a performance test 705, an integration test 707, or a security test 709. It may be appreciated that other tests are possible, in place of or in addition to those included herein, and may be considered within the scope of the present disclosure.

User interface 701 also includes various graphical representations of controls 711 selectable by a user to specify whether or not to run the specified tests in an instrumentation mode. For example, a user may select from an enable option and a disable option included in controls 711. Depending upon which test or tests are selected from tests 703, the resulting test would be run with either the instrumentation mode enabled or disabled. When enabled, proxy server 405 would instrument code in real-time and on-the-fly as described with respect to FIGS. 4-6. When disabled, proxy server 405 may still be used to retrieve code, but would refrain from instrumenting the code. In some scenarios, proxy server 405 may be disabled completely such that it is not used at all, but rather client 403 would communicate directly with code server 407 or via some other element to download code associated with an application targeted for testing.

FIG. 8 illustrates another exemplary user interface 801 that may be rendered and experienced by a user when interacting with testing application 401. User interface 801 includes various graphical representations of tests 803 selectable by a user to specify which test or tests to run against a target application. For example, a user may select from a performance test 805, an integration test 807, or a security test 809. It may be appreciated that other tests are possible, in place of or in addition to those included herein, and may be considered within the scope of the present disclosure.

User interface 801 also includes various graphical representations of controls 811 selectable by a user to specify whether or not to run the specified tests in an instrumentation mode. For example, a user may select either “yes” or “no” with respect to each of tests 803. Depending upon which test or tests are selected from tests 803, and depending upon how each selected tests is individual configured with respect to instrumentation, resulting test would be run with either the instrumentation mode enabled or disabled. When enabled, proxy server 405 would instrument code in real-time and on-the-fly as described with respect to FIGS. 4-6. When disabled, proxy server 405 may still be used to retrieve code, but would refrain from instrumenting the code. In some scenarios, proxy server 405 may be disabled completely such that it is not used at all, but rather client 403 would communicate directly with code server 407 or via some other element to download code associated with an application targeted for testing.

Since user interface 801 allows multiple tests to be selected but configured differently, a user may at times configure multiple tests to run simultaneously or in a specified order, but in different instrumentation modes. Since the code as it resides on code server 407 need not be in an instrumented for, any test can be run at any time in an instrumentation mode regardless of its sequence with respect to any other test running in a non-instrumented mode that requires non-instrumented code. This enhanced convenience may increase the likelihood that code coverage analysis is performed.

Referring back to FIG. 3, computing system 300 may also be representative of any computing system suitable for implementing all or portions of operational scenario 400, operational sequence 500, and operational scenario 600, illustrated in FIGS. 4-6 respectively, as well as the various elements represented therein, such as testing application 401, client 403, proxy server 405, and code server 407.

Computing system 300 includes processing system 301, storage system 303, software 305, communication interface system 307, and user interface system 309. Processing system 301 is operatively coupled with storage system 303, communication interface system 307, and user interface system 309. Processing system 301 loads and executes software 305 from storage system 303. When executed by processing system 301, software 305 directs processing system 301 to operate as described herein for instrumentation process 200 or its variations, and optionally any of the environments, user interfaces, and operational scenarios and sequences described herein. Computing system 300 may optionally include additional devices, features, or functionality not discussed for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variations thereof.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 303 may also include computer readable communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301 or possibly other systems.

Software 305 may be implemented in program instructions and among other functions may, when executed by processing system 301, direct processing system 301 to operate as described herein for instrumentation process 200 and its variations, and optionally as described herein with respect to various environments, operational scenarios, and operational sequences. In particular, the program instructions may include various components or modules that cooperate or otherwise interact to carry out instrumentation process 200. The various components or modules may be embodied in compiled or interpreted instructions or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform a suitable apparatus, system, or device (of which computing system 300 is representative) overall from a general-purpose computing system into a special-purpose computing system customized to facilitate real-time instrumentation as described herein for each implementation. Indeed, encoding software 305 on storage system 303 may transform the physical structure of storage system 303. The specific transformation of the physical structure may depend on various factors in different implementations of this description. Examples of such factors may include, but are not limited, to the technology used to implement the storage media of storage system 303 and whether the computer-storage media are characterized as primary or secondary storage, as well as other factors.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 300 is generally intended to represent a computing system or systems on which software 305 may be deployed and executed in order to implement instrumentation process 200 (or variations thereof) and optionally all or portions of the various environments and operational scenarios and sequences described herein. However, computing system 300 may also be suitable as any computing system on which software 305 may be staged and from where software 305 may be distributed, transported, downloaded, or otherwise provided to yet another computing system for deployment and execution, or yet additional distribution.

Communication interface system 307 may include communication connections and devices that allow for communication with other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 300 and any other computing system (not shown) may occur over a communication network or networks and in accordance with various communication protocols, such as the Internet protocol (IP, IPv4, IPv6, etc.), the transfer control protocol (TCP), and the user datagram protocol (UDP), as well as any other suitable communication protocol, variation, or combination thereof. Examples of communication networks over which computing system 300 may exchange information with other computing systems include intranets, the Internet, local area networks, wide area networks, wireless networks, wired networks, or any combination or variation thereof. The aforementioned communication networks and protocols are well known and need not be discussed at length here.

The manner and format in which information is exchanged may vary. In some implementations, an environment, application, server, or some other element, may exchange information with another environment, application, server, or other element in accordance with various protocols. Examples of some suitable protocols include, but are not limited to, various proprietary protocols, HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), FTP (file transfer protocol), SOAP (simple object access protocol), as well as any other suitable protocol, variation, extension, or combination of suitable protocols.

User interface system 309 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here. User interface system 309 may also include associated user interface software executable by processing system 301 in support of the various user input and output devices discussed above. Separately or in conjunction with each other and other hardware and software elements, the user interface software and user interface devices may support a graphical user interface, a natural user interface, or any other type of user interface.

It may be appreciated from the various implementations disclosed herein that the instrumentation step performed (often manually) prior to staging applications can be eliminated by instrumenting applications on-the-fly and in real-time. This reduces the effort needed for code coverage analysis, which may be especially beneficial with respect to applications with short release schedules or that are updated frequently.

In some implementations, an HTTP proxy based tool may be used to implement real-time instrumentation of JavaScript code. Such a tool may run as part of a browser-based framework. In such an implementation, a service in a test framework creates an HTTP proxy when running in a code coverage mode. The HTTP proxy is started on a client machine and listens to a fixed port. The service also programmatically changes the client machine's proxy settings to the specified port associated with the HTTP proxy. The HTTP proxy can listen to all traffic on that port.

At run-time, the HTTP proxy receives and parses HTTP request headers to detect HTTP GET requests for JavaScript files. Other requests can be transferred to their various destinations. For JavaScript GET requests, the corresponding body can be retrieved from a server and, once received, instrumented for code coverage. The HTTP proxy can then send the instrumented JavaScript file to browser for execution.

When the JavaScript file is executed within the context of a test, the instrumented code inserted into the JavaScript file will run, allow the test framework to detect which code blocks are hit. Corresponding code coverage information can reported and stored for later analysis and reporting. Once a test is complete, the HTTP proxy can be stopped.

The HTTP proxy may be implemented using a TCP listener and Sockets. A server socket is opened at the client-end of the HTTP proxy and acts as the server for incoming HTTP requests. A client socket is opened at the server-end of the HTTP proxy to mimic the client to the server from which code is downloaded.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for facilitating real-time code instrumentation comprising:
in an instrumentation environment, detecting a request initiated in an application environment to retrieve at least a portion of an application program for execution in the application environment;
in the instrumentation environment, and in response to detecting the request, retrieving application code associated with the application program from a code environment;
in the instrumentation environment, instrumenting the application code to generate instrumented code when operating in an instrumentation mode; and
in the instrumentation environment, replying to the request initiated in the application environment with at least a portion of the instrumented code.

2. The method of claim 1 wherein the application environment comprises a user interface control selectable to place the instrumentation environment in the instrumentation mode, wherein the method further comprises initiating presentation of the user interface control in a user interface to the application environment.

3. The method of claim 2 further comprising, in the instrumentation environment, not instrumenting the application code when not in the instrumentation mode and replying to the application environment with the application code as retrieved from the code environment.

4. The method of claim 3 wherein the application environment further comprises a test menu control selectable to designate to which test of a plurality of tests to submit the application program, wherein the method further comprises presenting a graphical representation of the test menu control in the user interface and submitting the application program to the test.

5. The method of claim 4 further comprising, in the instrumentation environment, analyzing code coverage of the test when in the instrumentation mode and not analyzing the code coverage of the test when not in the instrumentation mode.

6. The method of claim 1 wherein the application environment comprises a testing application and a browser application, wherein the instrumentation environment comprises a proxy server, and wherein the code environment comprises a production server.

7. The method of claim 6 wherein detecting the request comprises the proxy server examining a plurality of requests initiated from the browser application to identify any requesting JavaScript files, wherein the request comprises a Hypertext Transfer Protocol (HTTP) GET request for at least one JavaScript file.

8. An apparatus comprising:
one or more computer readable storage media; and
program instructions stored on the one or more computer readable storage media and comprising a proxy server for facilitating code coverage analysis that, when executed by a processing system, directs the processing system to at least:
detect a request initiated by a browser application to retrieve at least a portion of an application program for execution in the browser application;
in response to the request, retrieve application code associated with the application program from a code server;
instrument the application code to generate instrumented code when operating in an instrumentation mode; and
reply to the browser application with at least a portion of the instrumented code for execution in the browser application.

9. The apparatus of claim 8 wherein the program instructions further comprise a user interface control selectable to set the proxy server in the instrumentation mode, wherein user interface control, when executed by the processing system, directs the processing system to initiate presenting the user interface control in a user interface to a testing application.

10. The apparatus of claim 9 wherein the proxy server, when not in the instrumentation mode, directs the processing system to reply to the request initiated by the browser application with the application code as retrieved from the code server in a non-instrumented state.

11. The apparatus of claim 10 wherein the program instructions further comprise a test menu control selectable to designate to which test of a plurality of tests to submit the application program, wherein test menu control, when executed by the processing system, directs the processing system to initiate presenting the test menu control in the user interface to the testing application and submit the application program to the test.

12. The apparatus of claim 11 wherein the program instructions further comprise the testing application, wherein the testing application, when executed by the processing system, directs the processing system to analyze code coverage of the test when in the instrumentation mode and not analyze the code coverage of the test when not in the instrumentation mode.

13. The apparatus of claim 12 wherein the testing application, when executed by the processing system, further directs the processing system to load and execute the proxy server in the browser application.

14. The apparatus of claim 13 wherein to detect the request, the proxy server directs the processing system to examine a plurality of requests initiated from the browser application to identify any requesting JavaScript files, wherein the request comprises a Hypertext Transfer Protocol (HTTP) GET request for at least one JavaScript file.

15. One or more computer readable storage media having program instructions stored thereon comprising a testing application for facilitating tests of application programs and code coverage analysis of the tests, wherein the testing application, when executed by a computing system, directs the computing system to at least:
render a user interface control selectable to at least enable and disable an instrumentation mode in which a proxy server operates;
render a test menu control selectable to designate to which test of a plurality of tests to submit an application program;
drive a browser application to retrieve the application program via the proxy server and execute the application program in accordance with the test designated via the test menu control.

16. The one or more computer readable storage media of claim 15 wherein the program instructions further comprise the proxy server and wherein the proxy server, when executed by the computing system, directs the computing system to at least:
detect a request initiated by the browser application to retrieve at least a portion of the application program for execution in the browser application;
in response to the request, retrieve application code associated with the application program from a code server;
instrument the application code to generate instrumented code when operating in the instrumentation mode; and
reply to the request initiated by the browser application with at least a portion of the instrumented code for execution in the browser application.

17. The one or more computer readable storage media of claim 16 wherein the proxy server, when not in the instrumentation mode, directs the computing system system to reply to the request initiated by the browser application with the application code in a non-instrumented state.

18. The one or more computer readable storage media of claim 17 wherein the plurality of tests comprises a performance test, a security test, and a regression test.

19. The one or more computer readable storage media of claim 16 wherein the code server comprises a production server from where the application code is distributed live to clients.

20. The one or more computer readable storage media of claim 16 wherein the code server comprises a development server on which the application code is developed.
